(19) United States
(12) Patent Application Publication
(10) Pub. No.: US 2015/0063436 A1
(43) Pub. Date: Mar. 5, 2015

(54) METHOD FOR ENCODING AND DECODING AN IMAGE, AND CORRESPONDING DEVICES

(71) Applicants: Sébastien Lasserre, Rennes (FR); Fabrice Le Leannec, Mouaze (FR)

(72) Inventors: Sébastien Lasserre, Rennes (FR); Fabrice Le Leannec, Mouaze (FR)

(73) Assignee: CANON KABUSHIKI KAISHA, Tokyo (JP)

(21) Appl. No.: 14/129,522

(22) PCT Filed: Jun. 27, 2012
(86) PCT No.: PCT/EP2012/062512

§ 371 Date: Apr. 9, 2014

(30) Foreign Application Priority Data
Jun. 30, 2011 (GB) 1111195.2

(51) Int. Cl. H04N 19/625; H04N 19/124; H04N 19/60

(52) U.S. Cl. CPC H04N 19/625; H04N 19/60; H04N 19/124
USPC 375/240.2

(57) ABSTRACT

A method for encoding at least one block of pixels includes the following steps of transforming (18) pixel values for the block into a set of coefficients each having a coefficient type; determining, for each coefficient type, an estimated value representative of a ratio between a distortion variation provided by encoding a coefficient having the concerned type and a rate increase resulting from encoding the coefficient; subjecting coefficients of the set to a quantization step to produce quantized symbols, wherein the subjected coefficients form a subset of the set and wherein the estimated ratios for coefficient types of coefficients in the subset are larger than the highest estimated ratio over coefficient types of coefficients not included in the subset; encoding (193) the quantized symbol. Corresponding decoding method, encoding and decoding devices are also provided.

### FIELD OF THE INVENTION

The present invention concerns a method for encoding and decoding an image comprising blocks of pixels, and an associated encoding devices.

The invention is particularly useful for the encoding of digital video sequences made of images or “frames”.

### BACKGROUND OF THE INVENTION

Video compression algorithms, such as those standardized by the standardization organizations ITU, ISO, and SMPTE, exploit the spatial and temporal redundancies of images in order to generate bitstreams of data of smaller size than original video sequences. These powerful video compression tools, known as spatial (or intra) and temporal (or inter) predictions, make the transmission and/or the storage of video sequences more efficient.

Video encoders and/or decoders (codecs) are often embedded in portable devices with limited resources, such as cameras or camcorders. Conventional embedded codecs can process at best high definition (HD) digital videos, i.e 1080×1920 pixel frames.

Real time encoding is however limited by the limited resources of the portable devices, especially regarding slow access to the working memory (e.g. random access memory, or RAM) and regarding the central processing unit (CPU).

This is particularly striking for the encoding of ultra-high definition (UHD) digital videos that are about to be handled by the latest cameras. This is because the amount of pixel data to encode or to consider for spatial or temporal prediction is huge.

UHD is typically four times (4k2k pixels) the definition of an HD video which is the current standard definition video. Furthermore, very ultra high definition, which is sixteen times that definition (i.e. 8k4k pixels), is even being considered in a more long-term future.

### SUMMARY OF THE INVENTION

Faced with these encoding constraints in terms of limited power and memory access bandwidth, the inventors provide a UHD codec with low complexity based on scalable encoding.

Basically, the UHD video is encoded into a base layer and one or more enhancement layers.

The base layer results from the encoding of a reduced version of the UHD images, in particular having a HD resolution, with a standard existing codec (e.g. H.264 or HEVC—High Efficiency Video Coding). As stated above, the compression efficiency of such a codec relies on spatial and temporal predictions.

Further to the encoding of the base layer, an enhancement image is obtained from subtracting an interpolated (or up-scaled) decoded image of the base layer from the corresponding original UHD image. The enhancement images, which are residuals or pixel differences with UHD resolution, are then encoded into an enhancement layer.

FIG. 1 illustrates such approach at the encoder 10.

An input raw video 11, in particular a UHD video, is down-sampled 12 to obtain a so-called base layer, for example with HD resolution, which is encoded by a standard base video coder 13, for instance H.264/AVC or HEVC. This results in a base layer bit stream 14.

To generate the enhancement layer, the encoded base layer is decoded 15 and up-sampled 16 into the initial resolution (UHD in the example) to obtain the up-sampled decoded base layer.

The latter is then subtracted 17, in the pixel domain, from the original raw video to get the residual enhancement layer X.

The information contained in X is the error or pixel difference due to the base layer encoding and the up-sampling. It is also known as a “residual”.

A conventional block division is then applied, for instance a homogenous 8×8 block division (but other divisions with non-constant block size are also possible).

Next, a DCT transform 18 is applied to each block to generate DCT blocks forming the DCT image X_{DCT} having the initial UHD resolution.

This DCT image X_{DCT} is encoded in X_{DCT,Q}^{ENC} by an enhancement video encoding module 19 into an enhancement layer bit stream 20.

The encoded bit-stream EBS resulting from the encoding of the raw video 11 is made of:
the base layer bit-stream 14 produced by the base video encoder 13;
the enhancement layer bit-stream 20 encoded by the enhancement video encoder 19; and
parameters 21 determined and used by the enhancement video encoder.

Examples of those parameters are given here below.

FIG. 2 illustrates the associated processing at the decoder 30 receiving the encoded bit-stream EBS.

Part of the processing consists in decoding the base layer bit-stream 14 by the standard base video decoder 31 to produce a decoded base layer. This decoded base layer is up-sampled 32 into the initial resolution, i.e. UHD resolution.

In another part of the processing, both the enhancement layer bit-stream 20 and the parameters 21 are used by the enhancement video decoding module 33 to generate a dequantized DCT image X̅_{Q}_{^{−1}}^{DEC}. The image X̅_{Q}_{^{−1}}^{DEC} is the result of the quantization and then the inverse quantization on the image X_{DCT}.

An inverse DCT transform 34 is then applied to each block of the image X to obtain the decoded residual X̅_{IDCT,Q}_{^{−1}}^{DEC} (of UHD resolution) in the pixel domain.

This decoded residual X̅_{IDCT,Q}_{^{−1}}^{DEC} is added 35 to the up-sampled decoded base layer to obtain decoded images of the video.

Filter post-processing, for instance with a deblocking filter 36, is finally applied to obtain the decoded video 37 which is output by the decoder 30.

Reducing UHD encoding complexity relies on simplifying the encoding of the enhancement images at the enhancement video encoding module 19 compared to the conventional encoding scheme.

To that end, the inventors dispense with the temporal prediction and possibly the spatial prediction when encoding the UHD enhancement images. This is because the temporal prediction is very expensive in terms of memory bandwidth consumption, since it often requires accessing other enhancement images.

While this simplification reduces by 80% the slow memory random access bandwidth consumption during the encoding process, not using those powerful video compression tools may deteriorate the compression efficiency, compared to the conventional standards.

In this respect, the inventors have developed several additional tools for increasing the efficiency of the encoding of those enhancement images.

FIG. 3 illustrates an embodiment of the enhancement video encoding module 19 (or “enhancement layer encoder”) that is provided by the inventors.

In this embodiment, the enhancement layer encoder models 190 the statistical distribution of the DCT coefficients within the DCT blocks of a current enhancement image by fitting a parametric probabilistic model.

This fitted model becomes the channel model of DCT coefficients and the fitted parameters are output in the parameter bit-stream 21 coded by the enhancement layer encoder. As will become more clearly apparent below, a channel model may be obtained for each DCT coefficient position within a DCT block, i.e. each type of coefficient or each DCT channel, based on fitting the parametric probabilistic model onto the corresponding collocated DCT coefficients throughout all the DCT blocks of the image X_{DCT} or of part of it.

Based on the channel models, quantizers may be chosen 191 from a pool of pre-computed quantizers dedicated to each DCT channel as further explained below.

The chosen quantizers are used to perform the quantization 192 of the DCT image X_{DCT} to obtain the quantized DCT image X_{DCT,Q}.

Lastly, an entropy encoder 193 is applied to the quantized DCT image X_{DCt,Q} to compress data and generate the encoded DCT image X_{DCT,Q}^{ENC} which constitutes the enhancement layer bit-stream 20.

The associated enhancement video decoder 33 is shown in FIG. 4.

From the received parameters 21, the channel models are reconstructed and quantizers are chosen 330 from the pool of quantizers. As further explained below, quantizers used for dequantization may be selected at the decoder side using a process similar to the selection process used at the encoder side, based on parameters defining the channel models (which parameters are received in the data stream). Alternatively, the parameters transmitted in the data stream could directly identify the quantizers to be used for the various DCT channels.

An entropy decoder 331 is applied to the received enhancement layer bit-stream 20 ( X̅=X_{DCT,Q}^{ENC}) to obtain the quantized DCT image X̅^{DEC}.

A dequantization 332 is then performed by using the chosen quantizers, to obtain a dequantized version of the DCT image X̅_{Q}_{^{−1}}^{DEC}.

The channel modelling and the selection of quantizers are some of the additional tools as introduced above.

As will become apparent from the explanation below, those additional tools may be used for the encoding of any image, regardless of the enhancement nature of the image, and furthermore regardless of its resolution.

As briefly introduced above, the invention is particularly advantageous when encoding images without prediction.

According to a first aspect, the invention provides a method for encoding at least one block of pixels, the method comprising:
transforming pixel values for said block into a set of coefficients each having a coefficient type;
determining, for each coefficient type, an estimated value representative of a ratio between a distortion variation provided by encoding a coefficient having the concerned type and a rate increase resulting from encoding said coefficient;
subjecting coefficients of said set to a quantization step to produce quantized symbols, wherein the subjected coefficients form a subset of said set and wherein the estimated values for coefficient types of coefficients in said subset are larger than the highest estimated value over coefficient types of coefficients not included in said subset;
encoding the quantized symbols.

Thanks to the estimated value or ratio for each coefficient type, it is possible to order the various coefficient types by decreasing estimated value, i.e. by decreasing merit of encoding as explained below, and the encoding process may be applied only to coefficients having the higher values (i.e. ratios), forming the subset defined above.

Said distortion variation is for instance provided when no prior encoding has occurred for the coefficient having the concerned type. This amounts to taking into account the initial merit which makes it possible to keep an optimal result, as shown below.

The method may include a step of computing said pixel values by subtracting values obtained by decoding a base layer to values representing pixels of an image. The pixel values are for instance representative of residual data to be encoded into an enhancement layer.

The estimated value for the concerned coefficient type may be computed depending on a coding mode of a corresponding block in the base layer (i.e. for each of a plurality of such coding modes).

The following steps may also be included:
for each of a plurality of possible subsets each comprising a respective number of first coefficients when coefficients are ordered by decreasing estimated value of their respective coefficient type, selecting quantizers for coefficients of the concerned possible subset such that the distortions associated with the selected quantizers meet a predetermined criterion;
selecting, among said possible subsets, the subset minimising the rate obtained by using the quantizers selected for said subset, wherein the subset of subjected coefficients is the selected subset.

The number of coefficients to be quantized and encoded is thus determined during the optimisation process. A plurality of possible subsets are considered; however, as the coefficient types are ordered by decreasing encoding merit, only N+1 subsets need be considered if N is the total number of coefficients.

For instance, a quantizer is selected for each of a plurality of coefficient types, for each of a plurality of block sizes and for each of a plurality of base layer coding mode.

The step of selecting quantizers may be performed by selecting, among optimal quantizers each associated with a rate and corresponding distortion, an optimal quantizer for each coefficient type associated with the possible subset concerned, such that the sum of the rates associated with selected quantizers is minimal and the global distortion resulting from the distortions associated with said selected quantizers corresponds to a predetermined distortion. Such an implementation is particularly interesting in practice.

For each coefficient type, an optimal quantizer may be selected for each of a plurality of block sizes and for each of a plurality of base layer coding mode.

The method may further include, for at least one coefficient type, a step of determining a probabilistic model for coefficients of said at least one coefficient type based on a plurality of values of coefficients of said at least one coefficient type, wherein said estimated value for said at least one coefficient type is computed based on said probabilistic model. Ordering of coefficients according to their encoding merit may thus be performed based on the probabilistic model identified for the various coefficient types, which is a convenient way to take into account effective values of the coefficient in the process.

Said estimated value for a given coefficient type may in practice be computed using a derivative of a function associating rate and distortion of optimal quantizers for said coefficient type. Such rate and distortion of optimal quantizers are for example stored for a great number of possible values of the various parameters, as explained below. This allows a practical implementation.

Precisely, said estimated value for a given coefficient type may be determined by computing

$$\frac{2 {σ}_{n}^{2}}{{f}_{n}^{′} ( 0 )} ,$$

where σₙ is the standard variation among coefficients of said type and ƒ is a function associating rate Rₙ and distortion Dₙ of optimal quantizers for coefficients of said type n and defined as follows: Rₙ=ƒₙ(−ln(Dₙ/σₙ)). For instance, ƒₙ′(0) is determined using values stored in association with the determined probabilistic model.

The step of transforming pixel values corresponds for instance to a transformation from the spatial domain (pixels) to the frequency domain (e.g. into coefficients each corresponding to a specific spatial frequency). The transforming step includes for instance applying a block based Discrete Cosine Transform; each of said coefficient types may then correspond to a respective coefficient index.

According to a second aspect, the invention provides a method for decoding data representing at least one block of pixels, the method comprising:
decoding said data into at least one symbol;
dequantizing said at least one symbol into a dequantized coefficient having a coefficient type determined based on information associating each symbol to a coefficient type;
transforming dequantized coefficients, including said dequantized coefficient, into pixel values in the spatial domain for said block.

Thus, it is possible to decode and dequantize data corresponding only to a subset of the set of possible coefficients.

According to a possible embodiment, the method includes the following steps:
receiving data describing, for each coefficient type, a distribution model associated with the concerned coefficient type;
determining, for each possible coefficient type and based on the associated distribution model, an estimated value representative of a ratio between a distortion variation provided by encoding a coefficient having the concerned type and a rate increase resulting from encoding said coefficient;
determining said information associating each symbol to a coefficient type by ordering the coefficient types by decreasing corresponding estimated value.

The encoding priority or order may thus be reconstructed at the decoder based on information received in the data stream, as described below.

As a possible variation, the information associating each symbol to a coefficient type may itself be received in the datastream.

According to a third aspect, the invention provides a device for encoding at least one block of pixels, comprising:
means for transforming pixel values for said block into a set of coefficients each having a coefficient type;
means for determining, for each coefficient type, an estimated value representative of a ratio between a distortion variation provided by encoding a coefficient having the concerned type and a rate increase resulting from encoding said coefficient;
means for subjecting coefficients of said set to a quantization step to produce quantized symbols, wherein the subjected coefficients form a subset of said set and wherein the estimated values for coefficient types of coefficients in said subset are larger than the highest estimated value over coefficient types of coefficients not included in said subset;
means for encoding the quantized symbols.

According to a fourth aspect, the invention provides a device for decoding data representing at least one block of pixels comprising:
means for decoding said data into at least one symbol;
means for dequantizing said at least one symbol into a dequantized coefficient having a coefficient type determined based on information associating each symbol to a coefficient type;
means for transforming dequantized coefficients, including said dequantized coefficient, into pixel values in the spatial domain for said block.

Optional features proposed above in connection with the encoding method may also apply to the decoding method, the encoding device and the decoding device just mentioned.

The invention also provides information storage means, possibly totally or partially removable, able to be read by a computer system, comprising instructions for a computer program adapted to implement an encoding or decoding method as mentioned above, when this program is loaded into and executed by the computer system.

The invention also provides a computer program product able to be read by a microprocessor, comprising portions of software code adapted to implement an encoding or decoding method as mentioned above, when it is loaded into and executed by the microprocessor.

The invention also provides an encoding device for encoding an image substantially as herein described with reference to, and as shown in, FIGS. 1 and 3 of the accompanying drawings.

The invention also provides a decoding device for encoding an image substantially as herein described with reference to, and as shown in, FIGS. 2 and 4 of the accompanying drawings.

According to another aspect of the present invention, there is provided a method of encoding video data comprising:
receiving video data having a first resolution,
downsampling the received first-resolution video data to generate video data having a second resolution lower than said first resolution, and encoding the second resolution video data to obtain video data of a base layer having said second resolution; and
decoding the base layer video data, upsampling the decoded base layer video data to generate decoded video data having said first resolution, forming a difference between the generated decoded video data having said first resolution and said received video data having said first resolution to generate residual data, and compressing the residual data to generate video data of an enhancement layer.

Preferably, the compression of the residual data employs a method embodying the aforesaid first aspect of the present invention.

According to yet another aspect, the invention provides a method of decoding video data comprising:
decompressing video data of an enhancement layer to generate residual data having a first resolution;
decoding video data of a base layer to generate decoded base layer video data having a second resolution, lower than the first resolution, and upsampling the decoded base layer video data to generate upsampled video data having the first resolution;
forming a sum of the upsampled video data and the residual data to generate enhanced video data.

Preferably, the decompression of the residual data employs a method embodying the aforesaid second aspect of the present invention.

In one embodiment the encoding of the second resolution video data to obtain video data of a base layer having said second resolution and the decoding of the base layer video data are in conformity with HEVC.

In one embodiment, the first resolution is UHD and the second resolution is HD. As already noted, it is proposed that the compression of the residual data does not involve temporal prediction and/or that the compression of the residual data also does not involve spatial prediction.

### BRIEF DESCRIPTION OF THE DRAWINGS

Other particularities and advantages of the invention will also emerge from the following description, illustrated by the accompanying drawings, in which:

FIG. 1 schematically shows an encoder for a scalable codec;

FIG. 2 schematically shows the corresponding decoder;

FIG. 3 schematically illustrates the enhancement video encoding module of the encoder of FIG. 1;

FIG. 4 schematically illustrates the enhancement video decoding module of the encoder of FIG. 2;

FIG. 5 illustrates an example of a quantizer based on Voronoi cells;

FIG. 6 shows the correspondence between data in the spatial domain (pixels) and data in the frequency domain;

FIG. 7 illustrates an exemplary distribution over two quanta;

FIG. 8 shows exemplary rate-distortion curves, each curve corresponding to a specific number of quanta;

FIG. 9 shows the rate-distortion curve obtained by taking the upper envelope of the curves of FIG. 8;

FIG. 10 depicts several rate-distortion curves obtained for various possible parameters of the DCT coefficient distribution;

FIG. 11 shows the domain where the optimisation is carried out;

FIG. 12 depicts curves showing the convergence of the optimisation process used to select the quantizers to be used;

FIG. 13 shows a particular hardware configuration of a device able to implement methods according to the invention.

### DETAILED DESCRIPTION OF EMBODIMENTS OF THE INVENTION

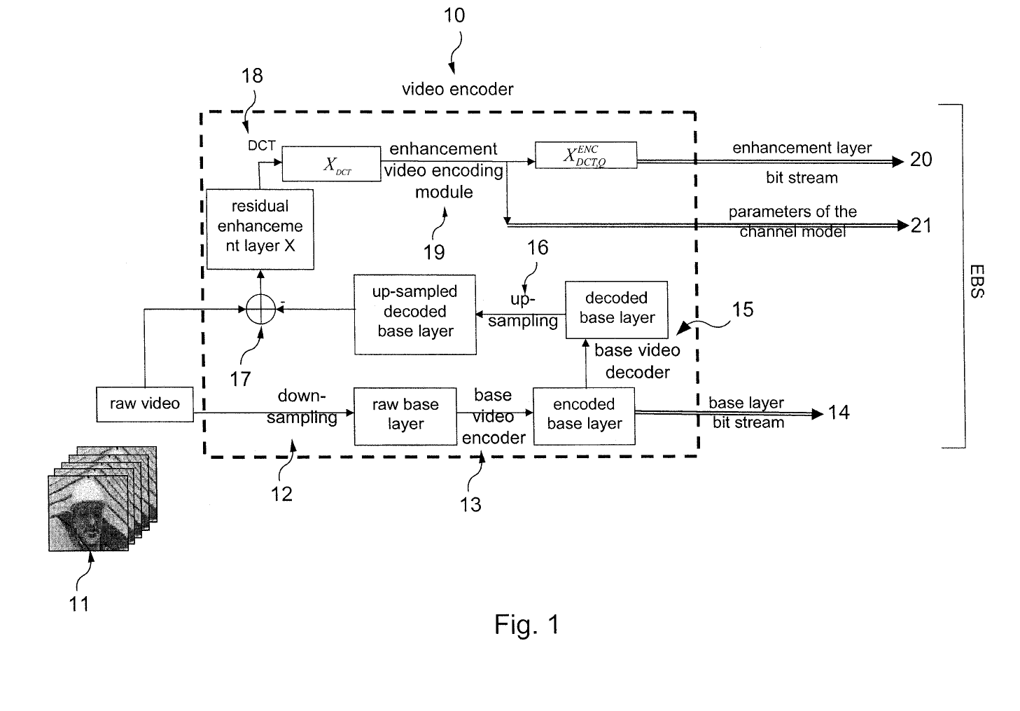

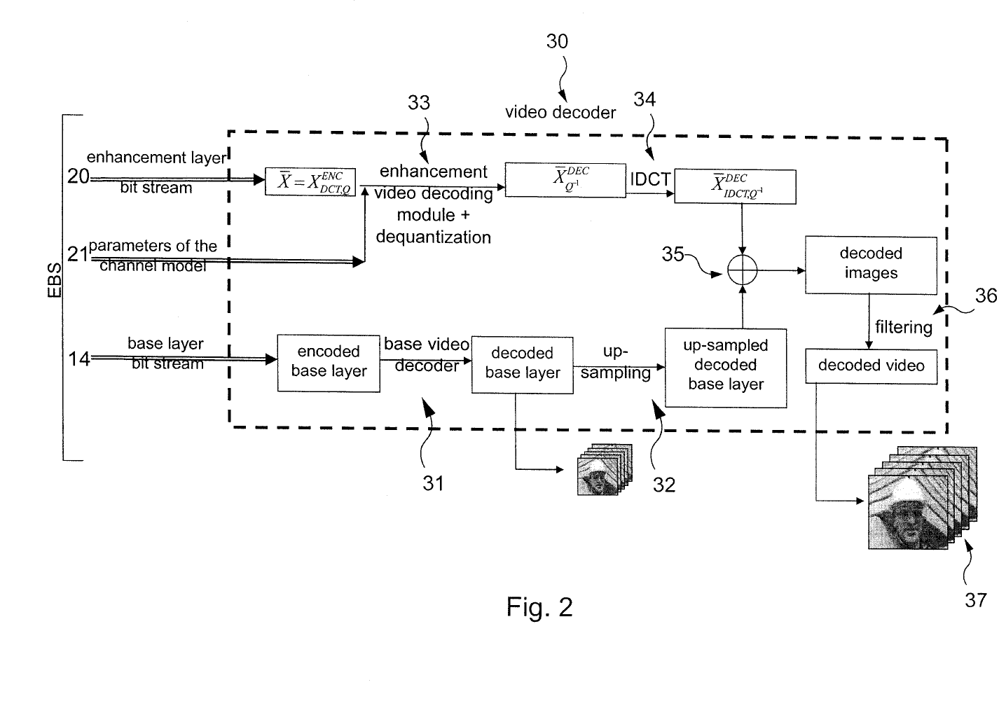

For the detailed description below, focus is made on the encoding of a UHD video as introduced above with reference to FIGS. 1 to 4. It is however to be recalled that the invention applies to the encoding of any image from which a probabilistic distribution of transformed block coefficients can be obtained (e.g. statistically). In particular, it applies to the encoding of an image without temporal prediction and possibly without spatial prediction.

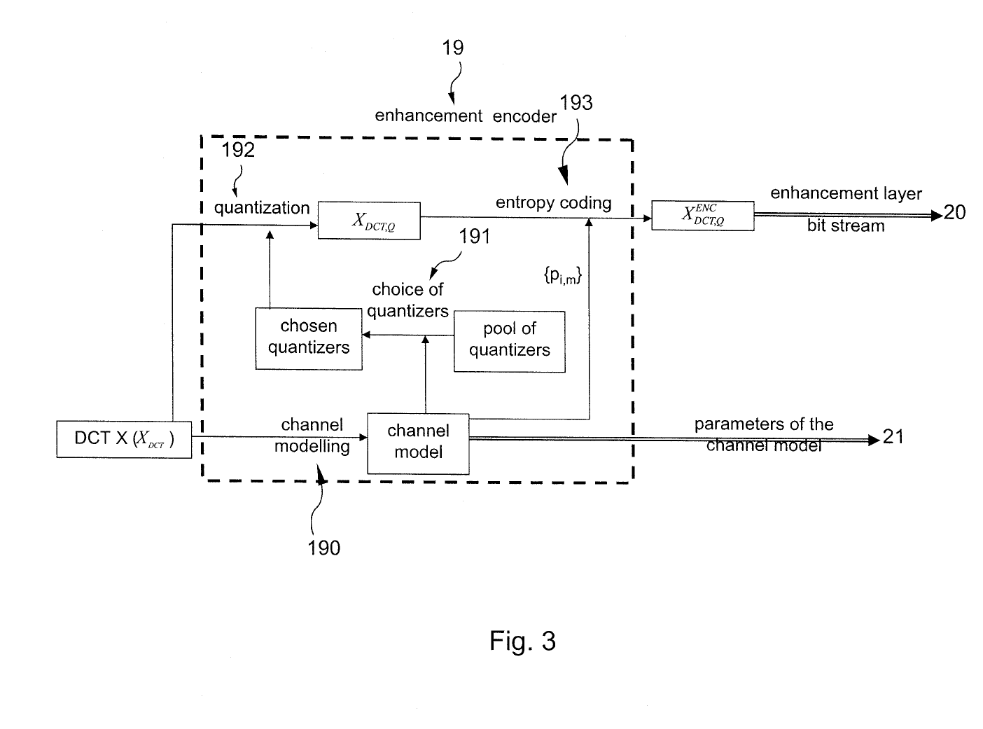

Referring again to FIG. 3, a low resolution version of the initial image has been encoded into an encoded low resolution image, referred above as the base layer; and a residual enhancement image has been obtained by subtracting an interpolated decoded version of the encoded low resolution image from said initial image.

Conventionally, that residual enhancement image is then transformed, using for example a DCT transform, to obtain an image of transformed block coefficients. In the Figure, that image is referenced X_{DCT}, which comprises a plurality of DCT blocks, each comprising DCT coefficients.

As an example, the residual enhancement image has been divided into blocks Bₖ, for instance 8×8 blocks but other divisions may be considered, on which the DCT transform is applied. Within a block, the DCT coefficients are associated with an index i (e.g. i=1 to 64), following an ordering used for successive handling when encoding, for example.

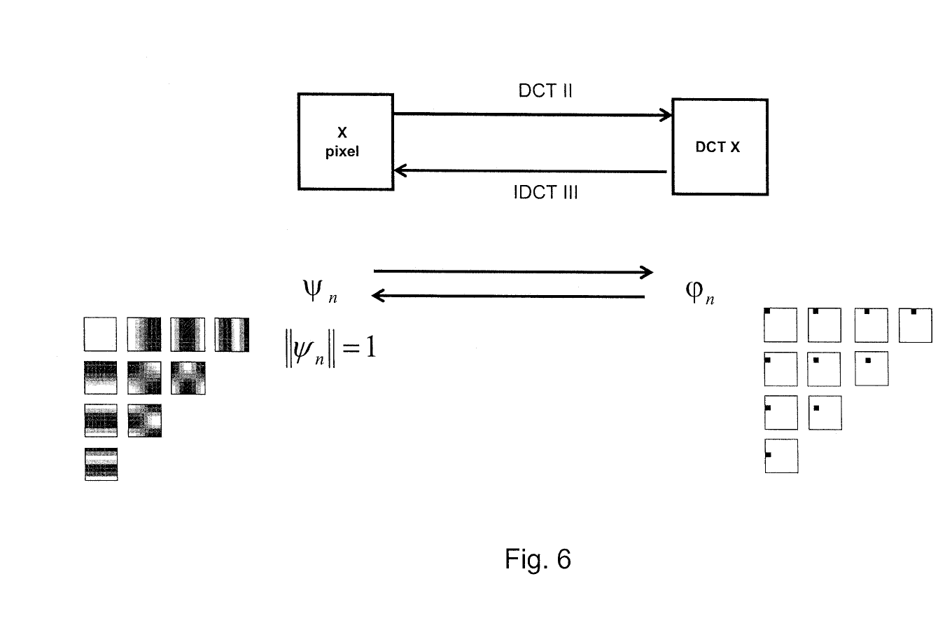

Blocks are grouped into macroblocks MBₖ. A very common case for so-called 4:2:0 YUV video streams is a macroblock made of 4 blocks of luminance Y, 1 block of chrominance U and 1 block of chrominance V, as illustrated in FIG. 6. Here too, other configurations may be considered.

In the example developed below, a macroblock MBₖ is made of 16×16 pixels of luminance Y and the chrominance has been down-sampled by a factor two both horizontally and vertically to obtain 8*8 pixels of chrominance U and 8*8 pixels of chrominance V. The four luminance blocks within a macroblock MBₖ are referenced Bₖ¹, Bₖ², Bₖ³, Bₖ⁴.

To simplify the explanations, only the coding of the luminance component is described below. However, the same approach can be used for coding the chrominance components.

Starting from the image X_{DCT}, a probabilistic distribution P of each DCT coefficient is determined using a parametric probabilistic model. This is referenced 190 in the Figure.

Since, in the present example, the image X_{DCT} is a residual image, i.e. information is about a noise residual, it is efficiently modelled by Generalized Gaussian Distributions (GGD) having a zero mean: DCT (X)≈GGD(α,β),

where α,β are two parameters to be determined and the GGD follows the following two-parameter distribution:

$$GGD ( α , β , x ) := \frac{β}{2 α Γ ( 1 / β )} exp ( - {\vert x / α \vert}^{β} ) ,$$

and where Γ is the well-known Gamma function: Γ(z)=∫₀^{∞}t^{z-1}e^{-t}dt.

The DCT coefficients cannot be all modelled by the same parameters and, practically, the two parameters α, β depend on:
the video content. This means that the parameters must be computed for each image or for every group of n images for instance;
the index i of the DCT coefficient within a DCT block Bₖ. Indeed, each DCT coefficient has its own behaviour. A DCT channel is thus defined for the DCT coefficients collocated (i.e. having the same index) within a plurality of DCT blocks (possibly all the blocks of the image). A DCT channel can therefore be identified by the corresponding coefficient index i;
the encoding mode used for the collocated block of the base layer, referred below as to the “base coding mode”. Typically, Intra blocks of the base layer do not behave the same way as Inter blocks, and blocks with a coded residual in the base layer do not behave the same way as blocks without such a residual (i.e. Skipped blocks).
the size of the block. The content of the image, and then the statistics of the DCT coefficients, may be strongly related to the size of the block because it is common to choose this size in function of the image content, for instance to use large blocks for parts of the image containing little information.

It is to be noted that, due to the down-sampling of the base layer, the collocation of blocks should take into account that down-sampling. For example, the four blocks of the n-th macroblock in the residual enhancement layer with UHD resolution are collocated with the n-th block of the base layer having a HD resolution. That is why, generally, all the blocks of a macroblock have the same base coding mode.

For illustrative purposes, if the residual enhancement image X_{DCT} is divided into 8×8 pixel blocks, the modelling 190 has to determine the parameters of 64 DCT channels for each base coding mode.

In addition, since the luminance component Y and the chrominance components U and V have dramatically different source contents, they must be encoded in different DCT channels. For example, if it is decided to encode the luminance component Y on one channel and the chrominance components UV on another channel, 128 channels are needed for each base coding mode.

At least 64 pairs of parameters for each base coding mode may appear as a substantial amount of data to transmit to the decoder (see parameter bit-stream 21). However, experience proves that this is quite negligible compared to the volume of data needed to encode the residuals of Ultra High Definition (4k2k or more) videos. As a consequence, one may understand that such a technique is preferably implemented on large videos, rather than on very small videos because the parametric data would take too much volume in the encoded bitstream.

For sake of simplicity of explanation, a set of DCT blocks corresponding to the same base coding mode and a unique size of blocks are now considered. The invention may then be applied to each set corresponding to each base coding mode or block size. Furthermore, as suggested above, the invention may be directly applied to the entire image, regardless the base coding modes.

To obtain the two parameters αᵢ, βᵢ defining the probabilistic distribution Pᵢ for a DCT channel i, the Generalized Gaussian Distribution model is fitted onto the DCT block coefficients of the DCT channel, i.e. the DCT coefficients collocated within the DCT blocks of the same base coding mode and block size. Since this fitting is based on the values of the DCT coefficients (of the DCT blocks having the same base coding mode in the example), the probabilistic distribution is a statistical distribution of the DCT coefficients within a considered channel i.

For example, the fitting may be simply and robustly obtained using the moment of order k of the absolute value of a GGD:

$$\begin{matrix}{M}_{k}^{{α}_{i} , {β}_{i}} := {E ( {\vert GGD ( {α}_{i} , {β}_{i} ) \vert}^{k} )}_{( k ∈ {R}_{+} )} \\ = {\int }_{- ∞}^{∞} {\vert x \vert}^{k} GGD ( {α}_{i} , {β}_{i} , x ) d x \\ = \frac{{α}_{i}^{k} Γ ( ( 1 + k ) / {β}_{i} )}{Γ ( 1 / {β}_{i} )} .\end{matrix}$$

Determining the moments of order 1 and of order 2 from the DCT coefficients of channel i makes it possible to directly obtain the value of parameter βᵢ:

$$\frac{{M}_{2}}{{( {M}_{1} )}^{2}} = \frac{Γ ( 1 / {β}_{i} ) Γ ( 3 / {β}_{i} )}{{Γ ( 2 / {β}_{i} )}^{2}}$$

The value of the parameter βᵢ can thus be estimated by computing the above ratio of the two first and second moments, and then the inverse of the above function of βᵢ.

Practically, this inverse function may be tabulated in memory of the encoder instead of computing Gamma functions in real time, which is costly.

The second parameter αᵢ may then be determined from the first parameter βᵢ and the second moment, using the equation: M₂=σ²=αᵢ²Γ(3/βᵢ)/Γ(1/βᵢ).

The two parameters αᵢ, βᵢ being determined for the DCT coefficients i, the probabilistic distribution Pᵢ of each DCT coefficient i is defined by

$$\begin{matrix}{P}_{i} ( x ) = GGD ( {α}_{i} , {β}_{i} , x ) \\ = \frac{{β}_{i}}{2 {α}_{i} Γ ( 1 / {β}_{i} )} exp ( - {\vert x / {α}_{i} \vert}^{{β}_{i}} ) .\end{matrix}$$

Still referring to FIG. 3, a quantization of the DCT coefficients is performed in order to obtain quantized symbols or values. As explained below, it is proposed to determine a quantizer per DCT channel so as to optimize a rate-distortion criterion.

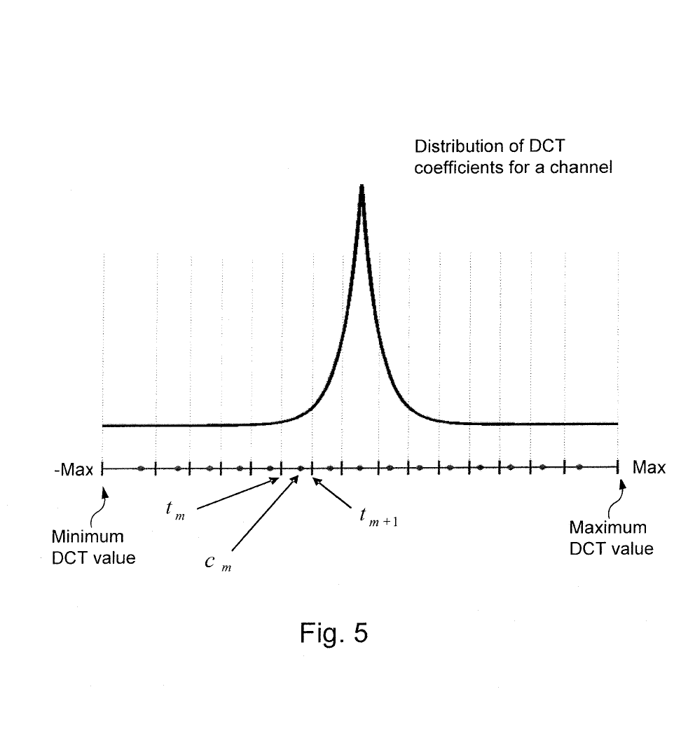

FIG. 5 illustrates an exemplary Voronoi cell based quantizer.

A quantizer is made of M Voronoi cells distributed along the values of the DCT coefficients. Each cell corresponds to an interval [tₘ,tₘ₊₁], called quantum Qₘ.

Each cell has a centroid cₘ, as shown in the Figure.

The intervals are used for quantization: a DCT coefficient comprised in the interval [tₘ,tₘ₊₁] is quantized to a symbol aₘ associated with that interval.

For their part, the centroids are used for de-quantization: a symbol aₘ associated with an interval is de-quantized into the centroid value cₘ of that interval.

The quality of a video or still image may be measured by the so-called Peak-Signal-to-Noise-Ratio or PSNR, which is dependent upon a measure of the L2-norm of the error of encoding in the pixel domain, i.e. the sum over the pixels of the squared difference between the original pixel value and the decoded pixel value. It may be recalled in this respect that the PSNR may be expressed in dB as:

$$10 \cdot {log}_{10} ( \frac{{MAX}^{2}}{MSE} ) ,$$

where MAX is the maximal pixel value (in the spatial domain) and MSE is the mean squared error (i.e. the above sum divided by the number of pixels concerned).

However, as noted above, most of video codecs compress the data in the DCT-transformed domain in which the energy of the signal is much better compacted.

The direct link between the PSNR and the error on DCT coefficients is now explained.

For a residual block, we note ψₙ its inverse DCT (or IDCT) pixel base in the pixel domain as shown on FIG. 6. If one uses the so-called IDCT III for the inverse transform, this base is orthonormal: ∥ψₙ∥=1.

On the other hand, in the DCT domain, the unity coefficient values form a base φₙ which is orthogonal. One writes the DCT transform of the pixel block X as follows:

$${X}_{DCT} = {\sum }_{n}^{ } {d}^{n} {ϕ}_{n} ,$$

where dⁿ is the value of the n-th DCT coefficient. A simple base change leads to the expression of the pixel block as a function of the DCT coefficient values:

$$\begin{matrix}X = IDCT ( {X}_{DCT} ) \\ = IDCT {\sum }_{n}^{ } {d}^{n} {ϕ}_{n} \\ = {\sum }_{n}^{ } {d}^{n} IDCT ( {ϕ}_{n} ) \\ = {\sum }_{n}^{ } {d}^{n} {ψ}_{n} .\end{matrix}$$

If the value of the de-quantized coefficient dⁿ after decoding is denoted d_{Q}ⁿ, one sees that (by linearity) the pixel error block is given by:

$${ɛ}_{X} = {\sum }_{n} ( {d}^{n} - {d}_{Q}^{n} ) {ψ}_{n}$$

The mean L₂-norm error on all blocks, is thus:

$$E ( {‖ {ɛ}_{X} ‖}_{2}^{2} ) = E ( {\sum }_{n} {\vert {d}^{n} - {d}_{Q}^{n} \vert}^{2} ) = {\sum }_{n} E ( {\vert {d}^{n} - {d}_{Q}^{n} \vert}^{2} ) = {\sum }_{n} {D}_{n}^{2}$$

where Dₙ² is the mean quadratic error of quantization on the n-th DCT coefficient, or squared distortion for this type of coefficient. The distortion is thus a measure of the distance between the original coefficient (here the coefficient before quantization) and the decoded coefficient (here the dequantized coefficient).

It is thus proposed below to control the video quality by controlling the sum of the quadratic errors on the DCT coefficients. In particular, this control is preferable compared to the individual control of each of the DCT coefficient, which is a priori a sub-optimal control.

In the embodiment described here, it is proposed to determine (i.e. to select in step 191 of FIG. 3) a set of quantizers (to be used each for a corresponding DCT channel), the use of which results in a mean quadratic error having a target value Dₜ² while minimising the rate obtained.

In view of the above correspondence between PSNR and the mean quadratic error Dₙ² on DCT coefficients, these constraints can be written as follows:

$$minimize R = {\sum }_{n} {R}_{n} ( {D}_{n} ) s . t . {\sum }_{n} {D}_{n}^{2} = {D}_{t}^{2} \qquad ( A )$$

where R is the total rate made of the sum of individual rates Rₙ for each DCT coefficient. In case the quantization is made independently for each DCT coefficient, the rate Rₙ depends only on the distortion Dₙ of the associated n-th DCT coefficient.

It may be noted that the above minimization problem (A) may only be fulfilled by optimal quantizers which are solution of the problem

minimize Rₙ(Dₙ) s.t. E(|dⁿ−d_{Q}ⁿ|²)=Dₙ² (B).

This statement is simply proven by the fact that, assuming a first quantizer would not be optimal following (B) but would fulfil (A), then a second quantizer with less rate but the same distortion can be constructed (or obtained). So, if one uses this second quantizer, the total rate R has been diminished without changing the total distortion ΣₙDₙ²; this is in contradiction with the first quantifier being a minimal solution of the problem (A).

As a consequence, the rate-distortion minimization problem (A) can be split into two consecutive sub-problems without losing the optimality of the solution:
first, determining optimal quantizers and their associated rate-distortion curves Rₙ(Dₙ) following the problem (B), which will be done in the present case for GGD channels as explained below;
second, by using optimal quantizers, the problem (A) is changed into the problem (A_opt):

$$minimize R = {\sum }_{n} {R}_{n} ( {D}_{n} ) s . t . {\sum }_{n} {D}_{n}^{2} = {D}_{t}^{2} and \\ {R}_{n} ( {D}_{n} ) is optimal . \qquad ( A\_opt )$$

Based on this analysis, it is proposed as further explained below:
to compute off-line optimal quantizers adapted to possible probabilistic distributions of each DCT channel (thus resulting in the pool of quantizers of FIG. 3);
to select one of these pre-computed optimal quantizers for each DCT channel (i.e. each type of DCT coefficient) such that using the set of selected quantizers results in a global distortion corresponding to the target distortion Dₜ² with a minimal rate (i.e. a set of quantizers which solves the problem A_opt).

It is now described a possible embodiment for the first step of computing optimal quantizers for possible probabilistic distributions, here Generalised Gaussian Distributions.

It is proposed to change the previous complex formulation of problem (B) into the so-called Lagrange formulation of the problem: for a given parameter λ>0, we determine the quantization in order to minimize a cost function such as D²+λR. We thus get an optimal rate-distortion couple (D_{λ},R_{λ}). In case of a rate control (i.e. rate minimisation) for a given target distortion Δₜ, the optimal parameter λ>0 is determined by

$${λ}_{{Δ}_{t}} = {arg min}_{λ , {D}_{λ} \leq {Δ}_{t}} {R}_{λ}$$

(i.e. the value of λ for which the rate is minimum while fulfilling the constraint on distortion) and the associated minimum rate is

$$minimize R = {\sum }_{n}^{ } {R}_{n} ( {D}_{n} ) s . t . {\sum }_{n}^{ } {D}_{n}^{2} = {D}_{t}^{2} \\ and \\ {R}_{n} ( {D}_{n} ) is optimal . \qquad ( A\_opt )$$

As a consequence, by solving the problem in its Lagrange formulation, for instance following the method proposed below, it is possible to plot a rate distortion curve associating a resulting minimum rate to each distortion value (Δₜ [symbol] R_{Δ}_{ₜ}) which may be computed off-line as well as the associated quantization, i.e. quantizer, making it possible to obtain this rate-distortion pair.

It is precisely proposed here to formulate problem (B) into a continuum of problems (B_lambda) having the following Lagrange formulation

minimize Dₙ²+λRₙ(Dₙ) s.t. E(|z−dₘ|²)=Dₙ² (B_lambda).

The well-known Chou-Lookabaugh-Gray algorithm is a good practical way to perform the required minimisation. It may be used with any distortion distance d; we describe here a simplified version of the algorithm for the L²-distance. This is an iterative process from any given starting guessed quantization.

As noted above, this algorithm is performed here for each of a plurality of possible probabilistic distributions (in order to obtain the pre-computed optimal quantizers for the possible distributions to be encountered in practice), and for a plurality of possible numbers M of quanta. It is described below when applied for a given probabistic distribution P and a given number M of quanta.

In this respect, as the parameter alpha α (or equivalently the standard deviation σ of the Generalized Gaussian Definition) can be moved out of the distortion parameter Dₙ² because it is a homothetic parameter, only optimal quantizers with unity standard deviation σ=1 need to be determined in the pool of quantizers.

Taking advantage of this remark, in the proposed embodiment, the GGD representing a given DCT channel will be normalized before quantization (i.e. homothetically transformed into a unity standard deviation GGD), and will be de-normalized after de-quantization. Of course, this is possible because the parameters (in particular here the parameter α or equivalently the standard deviation σ) of the concerned GGD model are sent to the decoder in the video bit-stream.

Before describing the algorithm itself, the following should be noted.

The position of the centroids cₘ is such that they minimize the distortion δₘ² inside a quantum, in particular one must verify that ∂_{c}_{ₘ}δₘ²=0 (as the derivative is zero at a minimum).

As the distortion δₘ of the quantization, on the quantum Qₘ, is the mean error E(d(x;cₘ)) for a given distortion function or distance d, the distortion on one quantum when using the L²-distance is given by δₘ²=∫_{Q}_{ₘ}|x−cₘ|²P(x)dx and the nullification of the derivative thus gives: cₘ=∫_{Q}_{ₘ}xP(x)dx/Pₘ, where Pₘ is the probability of x to be in the quantum Qₘ, and is simply the following integral Pₘ=∫_{Q}_{ₘ}P(x)dx.

Turning now to minimisation of the cost function C=D²+λR, and considering that the rate reaches the entropy of the quantized data:

$$R = - {\sum }_{m = 1}^{M} {P}_{m} {log}_{2} {P}_{m} ,$$

the nullification of the derivatives of the cost function for an optimal solution can be written as:

0=∂ₜ_{_{m−1}}C=∂ₜ_{ₘ₊₁}└Δₘ²−λPₘ ln Pₘ+Δₘ₊₁²−λPₘ₊₁ ln Pₘ₊₁┘

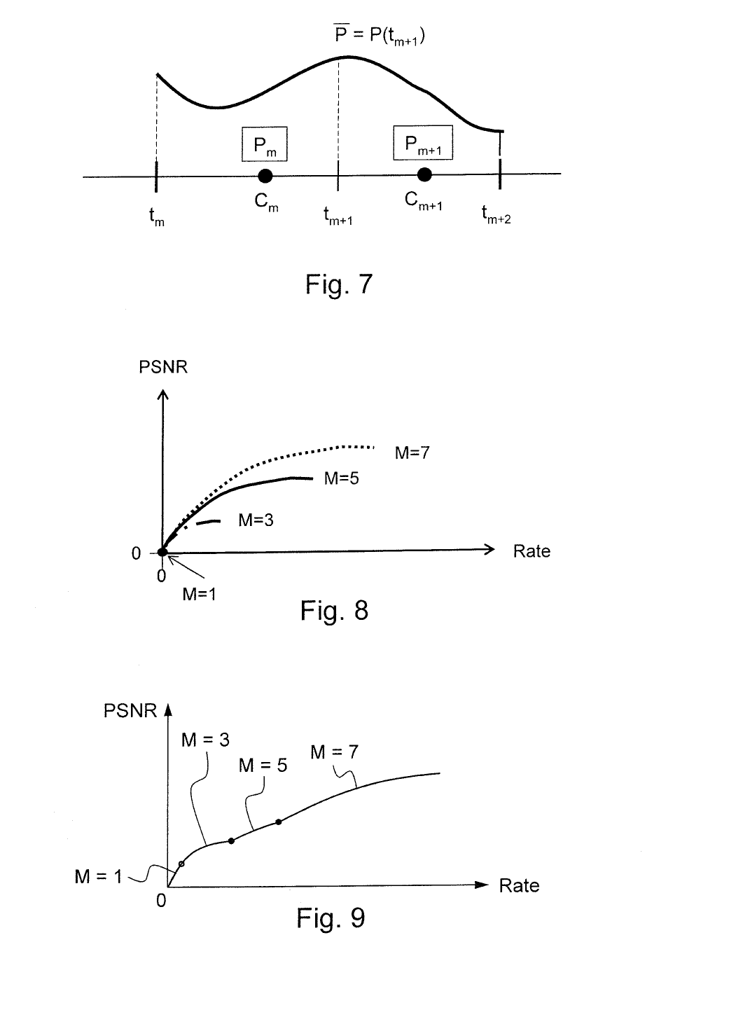

Let us set P̅=P(tₘ₊₁) the value of the probability distribution at the point tₘ₊₁. From simple variational considerations, see FIG. 7, we get

∂ₜ_{ₘ₊₁}Pₘ= P̅ and ∂ₜ_{ₘ₊₁}Pₘ₊₁=− P̅

Then, a bit of calculation leads to

$$\begin{matrix}{\partial }_{{t}_{m + 1}} {Δ}_{m}^{2} = {\partial }_{{t}_{m + 1}} {\int }_{m}^{{t}_{m + 1}} {\vert x - {c}_{m} \vert}^{2} P ( x ) d x \\ = \overline{P} {\vert {t}_{m + 1} - {c}_{m} \vert}^{2} + {\int }_{m}^{{t}_{m + 1}} {\partial }_{{t}_{m + 1}} {\vert x - {c}_{m} \vert}^{2} P ( x ) d x \\ = \overline{P} {\vert {t}_{m + 1} - {c}_{m} \vert}^{2} - 2 {\partial }_{{t}_{m + 1}} {c}_{m} {\int }_{m}^{{t}_{m + 1}} ( x - {c}_{m} ) P ( x ) d x \\ = \overline{P} {\vert {t}_{m + 1} - {c}_{m} \vert}^{2}\end{matrix}$$

as well as

∂ₜ_{ₘ₊₁}Δₘ₊₁²=− P̅|tₘ₊₁−cₘ₊₁|².

As the derivative of the cost is now explicitly calculated, its cancellation gives:

$$0 = \overline{P} {\vert {t}_{m + 1} - {d}_{m} \vert}^{2} - λ \overline{P} ln {P}_{m} - λ {P}_{m} \frac{\overline{P}}{{P}_{m}} - \overline{P} {\vert {t}_{m + 1} - {d}_{m + 1} \vert}^{2} + λ \overline{P} ln {P}_{m + 1} + λ {P}_{m} \frac{P}{{P}_{m}} ,$$

which leads to a useful relation between the quantum boundaries tₘ,tₘ₊₁ and the centroids cₘ:

$${t}_{m + 1} = \frac{{c}_{m} + {c}_{m + 1}}{2} - λ \frac{ln {P}_{m + 1} - ln {P}_{m}}{2 ( {c}_{m + 1} - {c}_{m} )} .$$

Thanks to these formulae, the Chou-Lookabaugh-Gray algorithm can be implemented by the following iterative process:

1. Start with arbitrary quanta Qₘ defined by a plurality of limits tₘ

2. Compute the probabilities Pₘ by the formula Pₘ=∫_{Q}_{ₘ}P(x)dx

3. Compute the centroids cₘ by the formula cₘ=∫_{Q}_{ₘ}xP(x)dx/Pₘ

4. Compute the limits tₘ of new quanta by the formula

$${t}_{m + 1} = \frac{{c}_{m} + {c}_{m + 1}}{2} - λ \frac{ln {P}_{m + 1} - ln {P}_{m}}{2 ( {c}_{m + 1} - {c}_{m} )}$$

5. Compute the cost C=D²+λR by the formula

$$C = {\sum }_{m = 1}^{M} {Δ}_{m}^{2} - λ {P}_{m}$$

### ln Pₘ

6. Loop to 2. until convergence of the cost C

When the cost C has converged, the current values of limits tₘ and centroids cₘ define a quantization, i.e. a quantizer, with M quanta, which solves the problem (B_lambda), i.e. minimises the cost function for a given value λ, and has an associated rate value R_{λ} and an distortion value D_{λ}.

Such a process is implemented for many values of the Lagrange parameter λ (for instance 100 values comprised between 0 and 50). It may be noted that for λ equal to 0, there is no rate constraint, which corresponds to the so-called Lloyd quantizer.

In order to obtain optimal quantizers for a given parameter β of the corresponding GGD, the problems (B_lambda) are to be solved for various odd (by symmetry) values of the number M of quanta and for the many values of the parameter λ. A rate-distortion diagram for the optimal quantizers with varying M is thus obtained, as shown on FIG. 8.

It turns out that, for a given distortion, there is an optimal number M of needed quanta for the quantization associated to an optimal parameter λ. In brief, one may say that optimal quantizers of the general problem (B) are those associated to a point of the upper envelope of the rate-distortion curves making this diagram, each point being associated with a number of quanta (i.e. the number of quanta of the quantizer leading to this point of the rate-distortion curve). This upper envelope is illustrated on FIG. 9. At this stage, we have now lost the dependency on λ of the optimal quantizers: for a given rate (or a given distortion) corresponds only one optimal quantizer whose number of quanta M is fixed.

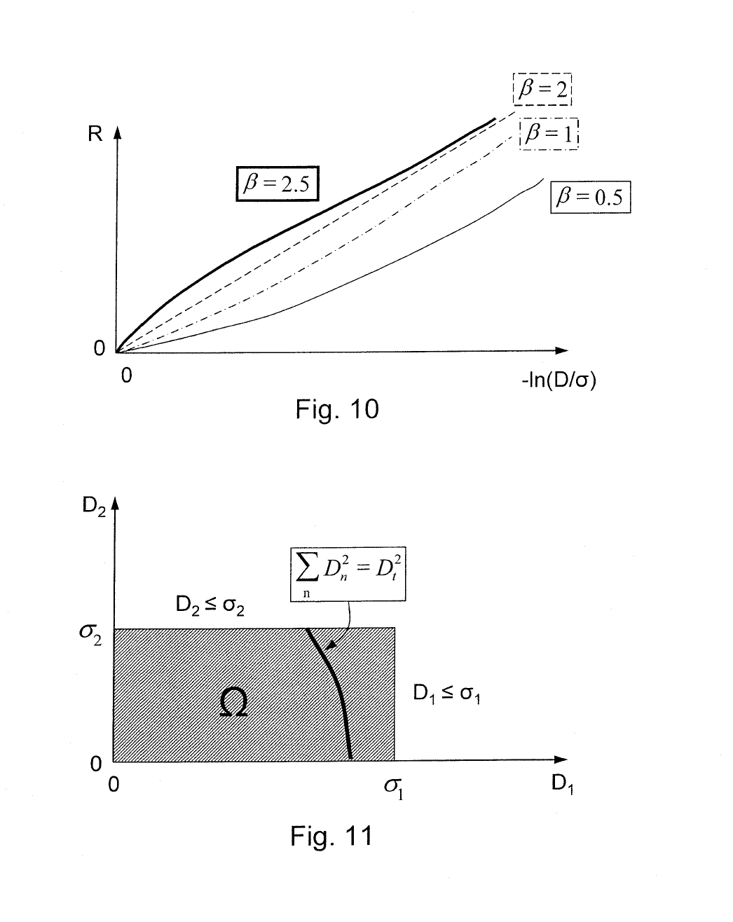

Based on observations that the GGD modelling provides a value of β almost always between 0.5 and 2 in practice, and that only a few discrete values are enough for the precision of encoding, it is proposed here to tabulate β every 0.1 in the interval between 0.2 and 2.5. Considering these values of β (i.e. here for each of the 24 values of β taken in consideration between 0.2 and 2.5), rate-distortion curves, depending on β, are obtained as shown on FIG. 10. It is of course possible to obtain according to the same process rate-distortion curves for a larger number of possible values of β.

Each curve may in practice be stored in the encoder in a table containing, for a plurality of points on the curve, the rate and distortion (coordinates) of the point concerned, as well as features defining the associated quantizer (here the number of quanta and the values of limits tₘ and centroids cₘ for the various quanta). For instance, a few hundreds of quantizers may be stored for each β up to a maximum rate, e.g. of 5 bits per DCT coefficient, thus forming the pool of quantizers mentioned in FIG. 3. It may be noted that a maximum rate of 5 bits per coefficient in the enhancement layer makes it possible to obtain good quality in the decoded image. Generally speaking, it is proposed to use a maximum rate per DCT coefficient equal or less than 10 bits, for which value near lossless coding is provided.

Before turning to the selection of quantizers, for the various DCT channels and among these optimal quantizers stored in association with their corresponding rate and distortion when applied to the concerned distribution (GGD with a specific parameter β), it is proposed here to possibly encode only part of the DCT channels.

Based on the observation that the rate decreases monotonously as a function of the distortion induced by the quantizer, precisely in each case in the manner shown by the curves just mentioned, it is possible to write the relationship between rate and distortion as follows: Rₙ=fₙ(−ln(Dₙ/σₙ)),

where σₙ is the normalization factor of the DCT coefficient, i.e. the GGD model associated to the DCT coefficient has σₙ for standard deviation, and where fₙ′≧0 in view of the monotonicity just mentioned.

In particular, without encoding (equivalently zero rate) leads to a quadratic distortion of value σₙ² and we deduce that 0=fₙ(0).

Finally, one observes that the curves are convex for parameters β lower than two: β≦2 [symbol] fₙ″≧0

It is proposed here to consider the merit of encoding a DCT coefficient. More encoding basically results in more rate Rₙ (in other words, the corresponding cost) and less distortion Dₙ² (in other words the resulting gain or advantage).

Thus, when dedicating a further bit to the encoding of the video (rate increase), it should be determined on which DCT coefficient this extra rate is the most efficient. In view of the analysis above, an estimation of the merit M of encoding may be obtained by computing the ratio of the benefit on distortion to the cost of encoding:

$${M}_{n} := \vert \frac{Δ {D}_{n}^{2}}{Δ {R}_{n}} \vert .$$

Considering the distortion decreases by an amount ε, then a first order development of distortion and rates gives

$${( D - ɛ )}^{2} = {D}^{2} - 2 ɛ D + o ( ɛ )$$

$$and$$

$$\begin{matrix}R ( D - ɛ ) = {f}_{n} ( - ln ( ( D - ɛ ) / σ ) ) \\ = {f}_{n} ( - ln ( D / σ ) - ln ( 1 - ɛ / D ) ) \\ = {f}_{n} ( - ln ( D / σ ) + ɛ / D + o ( ɛ ) ) \\ = {f}_{n} ( - ln ( D / σ ) ) + ɛ {f}^{′} ( - ln ( D / σ ) ) / D .\end{matrix}$$

As a consequence, the ratio of the first order variations provides an explicit formula for the merit of encoding:

$${M}_{n} ( {D}_{n} ) = \frac{2 {D}_{n}^{2}}{{f}_{n}^{′} ( - ln ( {D}_{n} / {σ}_{n} ) )} .$$

If the initial merit Mₙ⁰ is defined as the merit of encoding at zero rate, i.e. before any encoding, this initial merit Mₙ⁰ can thus be expressed as follows using the preceding formula:

$${M}_{n}^{0} := {M}_{n} ( {σ}_{n} ) = \frac{2 {σ}_{n}^{2}}{{f}_{n}^{′} ( 0 )}$$

(because as noted above no encoding leads to a quadratic distortion of value σₙ²).

It is thus possible, starting from the pre-computed and stored rate-distortion curves, to determine the function ƒₙ associated with a given DCT channel and to compute the initial merit Mₙ⁰ of encoding the corresponding DCT coefficient (the value ƒₙ′(0) being determined by approximation thanks to the stored coordinates of rate-distortion curves).

It may further be noted that, for β lower than two (which is in practice almost always true), the convexity of the rate distortion curves teaches us that the merit is an increasing function of the distortion.

In particular, the initial merit is thus an upper bound of the merit: Mₙ(Dₙ)≦Mₙ⁰.

In view of this, it is proposed to order the DCT coefficients by decreasing initial merit:

Mₙ_{₁}⁰≧Mₙ_{₂}⁰≧ . . . ≧Mₙ_{ₖ}⁰≧ . . . ,

and to encode only coefficients (non-nil-rate encoded DCT coefficients) which indexes are a left segment of the tuple (n₁, n₂, . . . , nₖ, . . . ). Said differently, after ordering the DCT channels in decreasing initial merit order, it is proposed to encode only a certain number of the first DCT channels taken in this order. This number may range from 0 (nothing is encoded) to the total number N of DCT channels considered (in which case each and every coefficient is in fact encoded).

The exact number of DCT channels to be encoded is determined during the quantizer selection process as explained below.

The optimality of this solution (encoding only the first coefficients ordered by initial merit) can be proven as follows.

If we assume that a first given DCT coefficient nᵢ is encoded and that there is another second DCT coefficient nⱼ which is not encoded and which has a higher initial merit, then an infinitesimal amount of coding rate can be taken from the first coefficient nᵢ to encode the second coefficient nⱼ. Because one has

Mₙ_{ⱼ}⁰≧Mₙ_{ᵢ}⁰≧Mₙ_{ᵢ}(Dₙ_{ᵢ}),

it is clear that one gets a lower distortion for the same rate. So, the encoding of the DCT coefficients is not optimal and one understands that, if a coefficient is encoded, then all coefficients with higher initial merits must be encoded.

As a corollary, if there are N DCT coefficients (or channels) per block, the number of possible configurations that should be envisaged when deciding which coefficients to encode drops from 2^{N} (decision for each coefficient whether it should be encoded) to N+1 (after ordering by decreasing initial merit, the number of coefficient may vary from 0 to N).

The encoding priority just mentioned does not specify whether a DCT coefficient is more or less encoded than another DCT coefficient; it indicates however that, if a DCT coefficient is encoded at a non-zero rate, then all coefficients with higher priority must be encoded at a non-zero rate.

The encoding priority provides an optimal encoding order that may be compared to the non optimal conventional zigzag scan coding order used in MPEG, JPEG, H.264 and HEVC standard video coding.

Based on the pre-computed optimal quantizers determined above and the possible sets of DCT channels to be encoded as just explained, it is possible to solve the optimisation problem (A_opt), i.e. to select one of these pre-computed optimal quantizers for each DCT channel to be encoded such that using the set of selected quantizers results in a global distortion corresponding to the target distortion Dₜ² with a minimal rate as follows. (This selection step corresponds to the choice referenced 191 in FIG. 3.)

The domain of optimization is as shown on FIG. 11. The quality constraint

$${\sum }_{n} {D}_{n}^{2} = {D}_{t}^{2}$$

can be rewritten as h=0 with

$$h ( {D}_{1} , {D}_{2} , … ) := {\sum }_{n}^{ } {D}_{n}^{2} - {D}_{t}^{2} .$$

The distortion of each DCT coefficient is upper bounded by the distortion without coding: Dₙ≦σₙ, and the domain of definition of the problem is thus a multi-dimensional box Ω={(D₁, D₂, . . . ); Dₙ≦σₙ}={(D₁, D₂, . . . ); gₙ≦0}, defined by the functions gₙ(Dₙ):=Dₙ−σₙ.

Thus, the problem can be restated as follows:

minimize R(D₁,D₂, . . . ) s.t. h=0,gₙ≦0 (A_opt′).

Such an optimization problem under inequality constrains is for instance solved using so-called Karush-Kuhn-Tucker (KKT) necessary conditions of optimality.

In this goal, the relevant KKT function Λ is defined as follows:

$$Λ ( {D}_{1} , {D}_{2} , … , λ , {μ}_{1} , {μ}_{2} , … ) := R - λ h - {\sum }_{n}^{ } {μ}_{n} {g}_{n} .$$

The KKT necessary conditions of minimization are
stationarity: dΛ=0,
equality: h=0,
inequality: gₙ≦0,
dual feasibility: μₙ≧0,
saturation: μₙgₙ=0.

It may be noted that the parameter λ in the KKT function above is unrelated to the parameter λ used above in the Lagrange formulation of the optimisation problem meant to determine optimal quantizers.

If gₙ=0, the n-th condition is said to be saturated. In the present case, it indicates that the n-th DCT coefficient is not encoded.

By using the specific formulation Rₙ=ƒₙ(−ln(Dₙ/σₙ)) of the rate depending on the distortion discussed above, the stationarity condition gives:

0=∂_{D}_{ₙ}Λ=∂_{D}_{ₙ}Rₙ−λ∂_{D}_{ₙ}h−μₙ∂_{D}_{ₙ}gₙ=−ƒₙ′/Dₙ−2λDₙ−μₙ,

i.e. 2λDₙ²=μₙDₙ−ƒₙ′.

By summing on n and taking benefit of the equality condition, this leads to

$$2 λ {D}_{t}^{2} = - {\sum }_{n}^{ } {μ}_{n} {D}_{n} - {\sum }_{n}^{ } {f}_{n}^{′} \cdot {(}^{*} )$$

In order to take into account the possible encoding of part of the coefficients only as proposed above, the various possible indices n are distributed into two subsets:
the set I⁰={n; μₙ=0} of non-saturated DCT coefficients (i.e. of encoded DCT coefficients) for which we have μₙDₙ=0 and Dₙ²=−ƒₙ′/2λ, and
the set I⁺={n; μₙ>0} of saturated DCT coefficients (i.e. of DCT coefficients not encoded) for which we have μₙDₙ=−ƒₙ′−2λσₙ².

From (*), we deduce

$$\begin{matrix}2 λ {D}_{t}^{2} = - {\sum }_{{I}^{+}}^{ } {μ}_{n} {D}_{n} - {\sum }_{n}^{ } {f}_{n}^{′} \\ = {\sum }_{{I}^{+}}^{ } {f}_{n}^{′} + 2 λ {\sum }_{{I}^{+}}^{ } {σ}_{n}^{2} - {\sum }_{n}^{ } {f}_{n}^{′}\end{matrix}$$

and by gathering the λ's

$$2 λ ( {D}_{t}^{2} - {\sum }_{{I}^{+}}^{ } {σ}_{n}^{2} ) = {\sum }_{{I}^{0}}^{ } {f}_{n}^{′} .$$

As a consequence, for a non-saturated coefficient (nεI⁰), i.e. a coefficient to be encoded), we obtain:

$${D}_{n}^{2} = ( {D}_{t}^{2} - {\sum }_{{I}^{+}}^{ } {σ}_{n}^{2} ) {f}_{n}^{′} ( - ln ( {D}_{n} / {σ}_{n} ) ) / {\sum }_{m ∈ {I}^{0}}^{ } {f}_{m}^{′} ( - ln ( {D}_{m} / {σ}_{m} ) ) .$$

It may be noted that this is an implicit system of equations because the derivatives ƒ′ depend on the distortions Dₙ. It is proposed to solve numerically this implicit system by a fixed point algorithm.

For a given set I⁰ of non-saturated coefficients, the above system can be rewritten \vec{D}=\vec{F}(\vec{D}),

using a continuous vector function \vec{F} and with \vec{D}=(D₁, D₂, . . . ). A fixed point method may be used to solve such a system by defining a series \vec{D}(t+1)=\vec{F}(\vec{D}(t)) and \vec{D}(0) arbitrary among the possible solutions (in the sub-space of the box Ω with dimensions corresponding to the set I⁰). If this series converges to a limit \vec{D}(∞), by continuity of the function \vec{F}, this limit is solution of the problem.

It may be noted in addition that, by theorem, the series converges if the function \vec{F} is a contracting function, i.e. if its differentiate is smaller than one. As this is not always the case, it is possible to force the convergence using a penalization method: the fixed point problem \vec{D}=\vec{F}(\vec{D}) can be rewritten as another fixed point problem:

\vec{D}=\vec{G}(\vec{D})=θ\vec{F}(\vec{D})+(1−θ)\vec{D}.

By taking the parameter θ close to zero, one can force the differentiate of G to be as close to one as wanted, ensuring the contraction of G. However use of very small θ's lead to a very slow convergence and a balance may thus be found in practice.

In view of the above, the practical algorithm for solving the implicit system defined above is as follows:

I. For each non-saturation set I⁰ of the N+1 possible non-saturation sets (provided by the priority of encoding as explained above), the iterative fixed point method is performed:
1. if

$${D}_{t}^{2} - {\sum }_{{I}^{+}}^{ } {σ}_{n}^{2} < 0 ,$$

encoding is impossible with the concerned non-saturation set I⁰;
2. start with arbitrary distortions Dₙ(0) (for nεI⁰), for example with Dₙ(0)=σₙ;
3. determine the distortions Dₙ(t+1) (for nεI⁰) thanks to the formula:

$${D}_{n}^{′2} = ( {D}_{t}^{2} - {\sum }_{{I}^{+}}^{ } {σ}_{n}^{2} ) {f}_{n}^{′} ( - ln ( {D}_{n} / {σ}_{n} ) ) / {\sum }_{m ∈ {I}^{0}}^{ } {f}_{m}^{′} ( - ln ( {D}_{m} ( t ) / {σ}_{m} ) )$$

and the penalization: Dₙ(t+1)=θD′+(1−θ)Dₙ(t)
for a fixed parameter θ. Compute the associated rate

$$R ( t + 1 ) = {\sum }_{n ∈ {I}_{0}}^{ } {R}_{n} ( t + 1 ) ,$$

where Rₙ(t+1) is the rate associated with the distortion Dₙ(t+1);
4. loop on 3. until convergence of the rates R(t+1), and store the final rate under R_{I}_{⁰};

II. determine the minimum rate Rₘᵢₙ among all rates Rᵢ_{⁰} (taken into account the N+1 possible non-saturation sets I⁰). The optimal DCT distortions Dₙ (for values of n belonging to the set I⁰ for which the minimum rate is obtained) are those associated with this minimum rate and were determined during the execution of the previous algorithm (I above). For each DCT channel to be encoded, the selected quantizer is the quantizer associated with the corresponding optimal distortion just obtained. It may be recalled in this respect that features (number of quanta, centroids and limit values) defining this quantizer are stored at the encoder in association with the distortion it generates, as already explained.

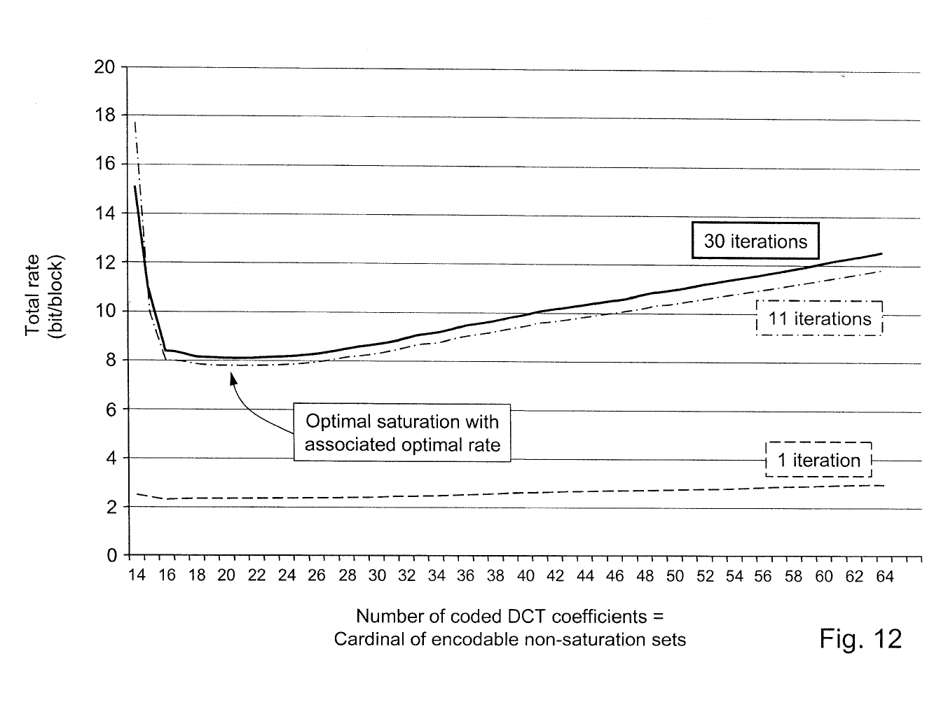

An example of convergence of the algorithm is shown on FIG. 12. One clearly understands than the optimal non-saturation is not trivial because it does not correspond to the smallest encodable one. Actually, the smallest encodable non-saturation implies a lot of effort of encoding for the encoded DCT coefficient and leads to a big encoding rate. By encoding more coefficients, i.e. taking a set bigger than the smallest encodable one, one does not need to encode the coefficient too much and the rate is smaller. On the other hand, encoding all coefficients is far from being optimal as seen on the figure; little rate is used on too many coefficients and finally this leads to a big total rate. The optimal set of non-saturation is a non trivial balance between the number of encoded coefficients and the amount of encoding on each coefficient.

Once the distortion target Dₙ (depending on the base mode) of each DCT coefficient has been determined by the above process, one chooses the best optimal quantizer associated to this distortion. For instance one may take, from the list of optimal quantizers corresponding to the associated parameter β of the DCT channel model, the quantizer with the least rate among quantizers having distortion less or equal than the target distortion Dₙ.

Then, quantization is performed by the chosen (or selected) quantizers to obtain the quantized data X_{DCT,Q} representing the DCT image. Practically, these data are symbols corresponding to the index of the quantum (or interval or Voronoi cell in 1D) in which the value of the concerned coefficient of X_{DCT} falls in.

The entropy coding may be performed by any known coding technique like VLC coding or arithmetic coding. Context adaptive coding (CAVLC or CABAC) may also be used.

The encoded data can then be transmitted together with parameters allowing in particular the decoder to use the same quantizers as those selected and used for encoding as described above.

According to a first possible embodiment, the transmitted parameters may include the parameters defining the distribution for each DCT channel, i.e. the parameter α (or equivalently the standard deviation σ) and the parameter β computed at the encoder side for each DCT channel.

Based on these parameters received in the data stream, the decoder may deduce the quantizers to be used (a quantizer for each DCT channel) thanks to the selection process explained above at the encoder side (the only difference being that the parameters β for instance are computed from the original data at the encoder side whereas they are received at the decoder side).

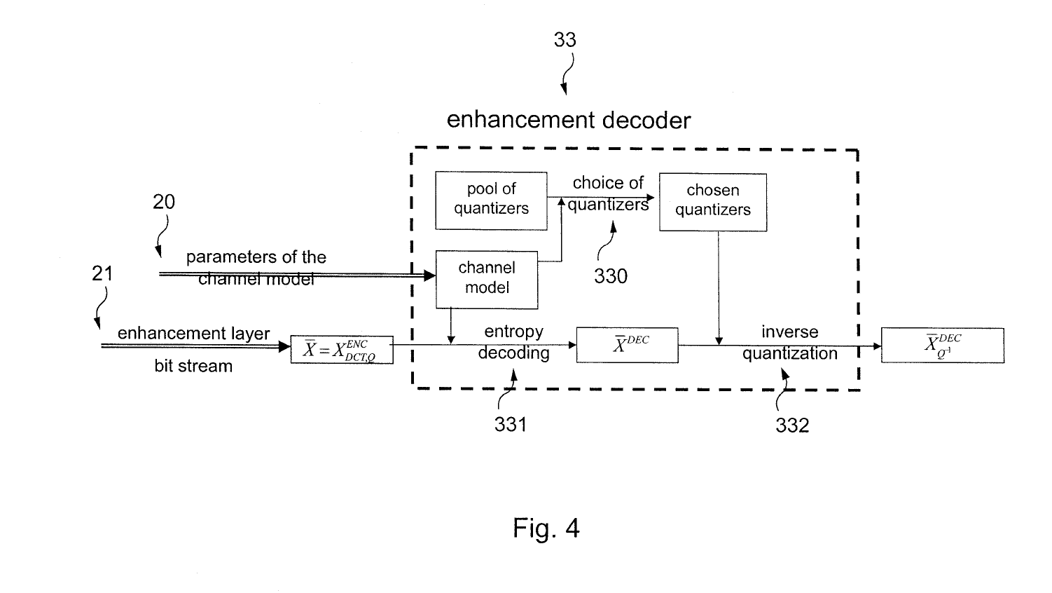

Dequantization (step 332 of FIG. 4) can thus be performed with the selected quantizers (which are the same as those used at encoding because they are selected the same way).

According to a possible variation of this first embodiment, the parameters transmitted in the data stream include a parameter representative of the set I⁰ of non-saturated coefficients which was determined at the encoder side to minimize the rate (i.e. the set for which the minimum rate Rₘᵢₙ was obtained). In this variation, it is thus unnecessary to seek the relevant non-saturated coefficient set by optimisation and the process of selecting quantizers to be used is thus faster (part I of the process described above only).

According to a second possible embodiment, the transmitted parameters may include identifiers of the various quantizers used in the pool of quantizers (this pool being common to the encoder and the decoder) and the standard deviation σ (or equivalently the parameter α).

Dequantization (step 332 of FIG. 4) can thus be performed at the decoder by use of the identified quantizers.

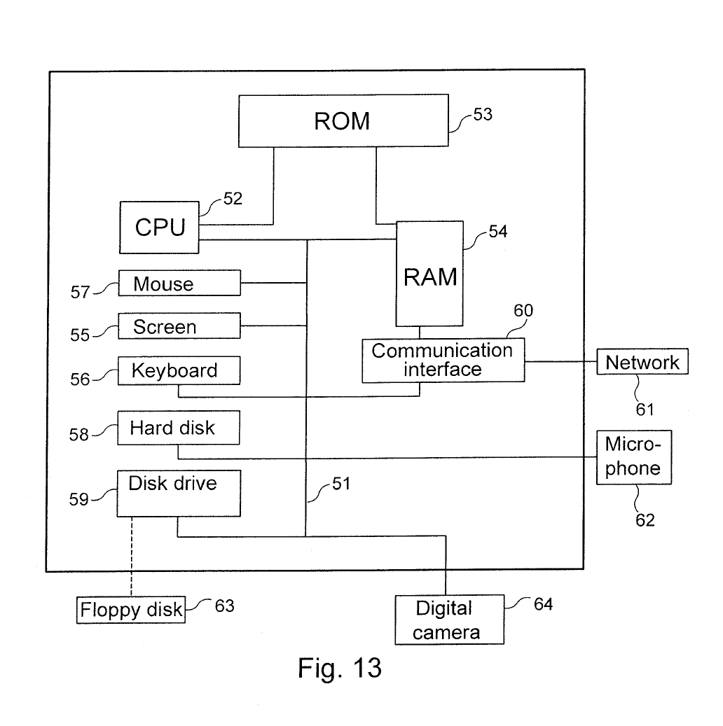

With reference now to FIG. 13, a particular hardware configuration of a device for encoding or decoding images able to implement methods according to the invention is now described by way of example.

A device implementing the invention is for example a microcomputer 50, a workstation, a personal digital assistant, or a mobile telephone connected to various peripherals. According to yet another embodiment of the invention, the device is in the form of a photographic apparatus provided with a communication interface for allowing connection to a network.

The peripherals connected to the device comprise for example a digital camera 64, or a scanner or any other image acquisition or storage means, connected to an input/output card (not shown) and supplying image data to the device.

The device 50 comprises a communication bus 51 to which there are connected:
a central processing unit CPU 52 taking for example the form of a microprocessor;
a read only memory 53 in which may be contained the programs whose execution enables the methods according to the invention. It may be a flash memory or EEPROM;
a random access memory 54, which, after powering up of the device 50, contains the executable code of the programs of the invention necessary for the implementation of the invention. As this memory 54 is of random access type (RAM), it provides fast access compared to the read only memory 53. This RAM memory 54 stores in particular the various images and the various blocks of pixels as the processing is carried out (transform, quantization, storage of the reference images) on the video sequences;
a screen 55 for displaying data, in particular video and/or serving as a graphical interface with the user, who may thus interact with the programs according to the invention, using a keyboard 56 or any other means such as a pointing device, for example a mouse 57 or an optical stylus;
a hard disk 58 or a storage memory, such as a memory of compact flash type, able to contain the programs of the invention as well as data used or produced on implementation of the invention;
an optional diskette drive 59, or another reader for a removable data carrier, adapted to receive a diskette 63 and to read/write thereon data processed or to process in accordance with the invention; and
a communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing a video sequence, and which may possibly be removable, is adapted to store one or more programs whose execution permits the implementation of the method according to the invention.

The executable code enabling the coding device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

The device described here and, particularly, the central processing unit 52, may implement all or part of the processing operations described in relation with FIGS. 1 to 12, to implement methods according to the present invention and constitute devices according to the present invention.

The above examples are merely embodiments of the invention, which is not limited thereby.

1. A method for encoding at least one block of pixels, the method comprising:
transforming pixel values for said block into a set of coefficients each having a coefficient type;
determining, for each coefficient type, an estimated value representative of a ratio between a distortion variation provided by encoding a coefficient having the concerned type and a rate increase resulting from encoding said coefficient;
subjecting coefficients of said set to a quantization step to produce quantized symbols, wherein the subjected coefficients form a subset of said set and wherein the estimated values for coefficient types of coefficients in said subset are larger than the highest estimated value over coefficient types of coefficients not included in said subset;
encoding the quantized symbols.

2. A method according to claim 1, wherein said distortion variation is provided when no prior encoding has occurred for the coefficient having the concerned type.

3. A method according to claim 1, comprising a step of computing said pixel values by subtracting values obtained by decoding a base layer to values representing pixels of an image.

4. A method according to claim 1, comprising a step of computing said pixel values by subtracting values obtained by decoding a base layer to values representing pixels of an image, wherein said distortion variation is provided when no prior encoding has occurred for the coefficient having the concerned type and wherein the estimated value for the concerned coefficient type depends on a coding mode of a corresponding block in the base layer.

5. A method according to claim 1, comprising the following steps:
for each of a plurality of possible subsets each comprising a respective number of first coefficients when coefficients are ordered by decreasing estimated value of their respective coefficient type, selecting quantizers for coefficients of the concerned possible subset such that the distortions associated with the selected quantizers meet a predetermined criterion; and
selecting, among said possible subsets, the subset minimising the rate obtained by using the quantizers selected for said subset, wherein the subset of subjected coefficients is the selected subset.

6. A method according to claim 5, wherein a quantizer is selected for each of a plurality of coefficient types, for each of a plurality of block sizes and for each of a plurality of base layer coding mode.

7. A method according to claim 5, wherein the step of selecting quantizers is performed by selecting, among optimal quantizers each associated with a rate and corresponding distortion, an optimal quantizer for each coefficient type associated with the possible subset concerned, such that the sum of the rates associated with selected quantizers is minimal and the global distortion resulting from the distortions associated with said selected quantizers corresponds to a predetermined distortion.

8. A method according to claim 7, wherein, for each coefficient type, an optimal quantizer is selected for each of a plurality of block sizes and for each of a plurality of base layer coding mode.

9. A method according to claim 1, including, for at least one coefficient type, a step of determining a probabilistic model for coefficients of said at least one coefficient type based on a plurality of values of coefficients of said at least one coefficient type, wherein said estimated value for said at least one coefficient type is computed based on said probabilistic model.

10. A method according to claim 1, wherein said estimated value for a given coefficient type is computed using a derivative of a function associating rate and distortion of optimal quantizers for said coefficient type.

11. A method according to claim 1, wherein said estimated value for a given coefficient type is determined by computing
$$\frac{2 {σ}_{n}^{2}}{{f}_{n}^{′} ( 0 )} ,$$
where σₙ is the standard variation among coefficients of said type and ƒ is a function associating rate Rₙ and distortion Dₙ of optimal quantizers for coefficients of said type n and defined as follows: Rₙ=ƒₙ(−ln(Dₙ/σₙ)).

12. A method according to claim 1, including, for at least one coefficient type, a step of determining a probabilistic model for coefficients of said at least one coefficient type based on a plurality of values of coefficients of said at least one coefficient type, wherein said estimated value for said at least one coefficient type is determined by computing
$$\frac{2 {σ}_{n}^{2}}{{f}_{n}^{′} ( 0 )} ,$$
where σₙ is the standard variation among coefficients of said at least one coefficient type and ƒ is a function associating rate Rₙ and distortion Dₙ for the determined probabilistic model and defined as follows: Rₙ=ƒₙ(−ln(Dₙ/σₙ)), and wherein ƒₙ′(0) is determined using values stored in association with the determined probabilistic model.

13. A method according to claim 1, wherein the transforming step includes applying a block based Discrete Cosine Transform and wherein each of said coefficient types corresponds to a respective coefficient index.

14. A method for decoding data representing at least one block of pixels, the method comprising:
decoding said data into at least one symbol;
dequantizing said at least one symbol into a dequantized coefficient having a coefficient type determined based on information associating each symbol to a coefficient type;
transforming dequantized coefficients, including said dequantized coefficient, into pixel values in the spatial domain for said block.

15. A method according to claim 14, comprising the following steps:
receiving data describing, for each coefficient type, a distribution model associated with the concerned coefficient type;
determining, for each possible coefficient type and based on the associated distribution model, an estimated value representative of a ratio between a distortion variation provided by encoding a coefficient having the concerned type and a rate increase resulting from encoding said coefficient;
determining said information associating each symbol to a coefficient type by ordering the coefficient types by decreasing corresponding estimated value.

16. A device for encoding at least one block of pixels, comprising:
means for transforming pixel values for said block into a set of coefficients each having a coefficient type;
means for determining, for each coefficient type, an estimated value representative of a ratio between a distortion variation provided by encoding a coefficient having the concerned type and a rate increase resulting from encoding said coefficient;
means for subjecting coefficients of said set to a quantization step to produce quantized symbols, wherein the subjected coefficients form a subset of said set and wherein the estimated values for coefficient types of coefficients in said subset are larger than the highest estimated value over coefficient types of coefficients not included in said subset;
means for encoding the quantized symbols.

17. A device according to claim 16, wherein said distortion variation is provided when no prior encoding has occurred for the coefficient having the concerned type.

18. A device according to claim 16, comprising means for computing said pixel values by subtracting values obtained by decoding a base layer to values representing pixels of an image.

19. A device according to claim 16, comprising means for computing said pixel values by subtracting values obtained by decoding a base layer to values representing pixels of an image, wherein said distortion variation is provided when no prior encoding has occurred for the coefficient having the concerned type and wherein the estimated value for the concerned coefficient type depends on a coding mode of a corresponding block in the base layer.

20. A device according to claim 16, comprising:
means for selecting, for each of a plurality of possible subsets each comprising a respective number of first coefficients when coefficients are ordered by decreasing estimated value of their respective coefficient type, quantizers for coefficients of the concerned possible subset such that the distortions associated with the selected quantizers meet a predetermined criterion;
means for selecting, among said possible subsets, the subset minimising the rate obtained by using the quantizers selected for said subset, wherein the subset of subjected coefficients is the selected subset.

21. A device according to claim 20, wherein the means for selecting quantizers is adapted to select a quantizer for each of a plurality of coefficient types, for each of a plurality of block sizes and for each of a plurality of base layer coding mode.

22. A device according to claim 20, wherein the means for selecting quantizers includes means for selecting, among optimal quantizers each associated with a rate and corresponding distortion, an optimal quantizer for each coefficient type associated with the possible subset concerned, such that the sum of the rates associated with selected quantizers is minimal and the global distortion resulting from the distortions associated with said selected quantizers corresponds to a predetermined distortion.

23. A device according to claim 22, wherein the means for selecting optimal quantizers for each coefficient type, is adapted to select an optimal quantizer for each of a plurality of block sizes and for each of a plurality of base layer coding mode.

24. A device according to claim 16, including means for determining, for at least one coefficient type, a probabilistic model for coefficients of said at least one coefficient type based on a plurality of values of coefficients of said at least one coefficient type, and means for computing said estimated value for said at least one coefficient type based on said probabilistic model.

25. A device according to claim 16, including means for computing said estimated value for a given coefficient type using a derivative of a function associating rate and distortion of optimal quantizers for said coefficient type.

26. A device according to claim 16, including means for determining estimated value for a given coefficient type by computing
$$\frac{2 {σ}_{n}^{2}}{{f}_{n}^{′} ( 0 )} ,$$
where σₙ is the standard variation among coefficients of said type and ƒ is a function associating rate Rₙ and distortion Dₙ of optimal quantizers for coefficients of said type n and defined as follows: Rₙ=ƒₙ(−ln(Dₙ/σₙ)).

27. A device according to claim 16, including means for determining, for at least one coefficient type, a probabilistic model for coefficients of said at least one coefficient type based on a plurality of values of coefficients of said at least one coefficient type, means for determining said estimated value for said at least one coefficient type by computing
$$\frac{2 {σ}_{n}^{2}}{{f}_{n}^{′} ( 0 )} ,$$
where σₙ is the standard variation among coefficients of said at least one coefficient type and ƒ is a function associating rate Rₙ and distortion Dₙ for the determined probabilistic model and defined as follows: Rₙ=ƒₙ(−ln(Dₙ/σₙ)), and means for determining ƒₙ′(0) using values stored in association with the determined probabilistic model.

28. A device according to claim 16, wherein the means for transforming includes means for applying a block based Discrete Cosine Transform and wherein each of said coefficient types corresponds to a respective coefficient index.

29. A device for decoding data representing at least one block of pixels comprising:
means for decoding said data into at least one symbol;
means for dequantizing said at least one symbol into a dequantized coefficient having a coefficient type determined based on information associating each symbol to a coefficient type;
means for transforming dequantized coefficients, including said dequantized coefficient, into pixel values in the spatial domain for said block.

30. A computer readable storage medium storing a program for causing a computer to execute a method comprising:
transforming pixel values for a block into a set of coefficients each having a coefficient type;
determining, for each coefficient type, an estimated value representative of a ratio between a distortion variation provided by encoding a coefficient having the concerned type and a rate increase resulting from encoding the coefficient;
subjecting coefficients of the set to a quantization step to produce quantized symbols, wherein the subjected coefficients form a subset of the set and wherein the estimated values for coefficient types of coefficients in the subset are larger than the highest estimated value over coefficient types of coefficients not included in the subset; and
encoding the quantized symbols.

31. (canceled)

32. A method of encoding video data comprising:
receiving video data having a first resolution,
downsampling the received first resolution video data to generate video data having a second resolution lower than said first resolution, and encoding the second resolution video data to obtain video data of a base layer having said second resolution; and
decoding the base layer video data, upsampling the decoded base layer video data to generate decoded video data having said first resolution, forming a difference between the generated decoded video data having said first resolution and said received video data having said first resolution to generate residual data, and compressing, by a method according to claim 1, the residual data to generate video data of an enhancement layer.

33. A method of decoding video data comprising:
decompressing, by a method according to claim 14, video data of an enhancement layer to generate residual data having a first resolution;
decoding video data of a base layer to generate decoded base layer video data having a second resolution, lower than the first resolution, and upsampling the decoded base layer video data to generate upsampled video data having the first resolution; and
forming a sum of the upsampled video data and the residual data to generate enhanced video data.
